(19) United States
(12) Patent Application Publication
(10) Pub. No.: US 2015/0055355 A1
(43) Pub. Date: Feb. 26, 2015

(54) LIGHT EMITTING MODULE

(71) Applicant: Lextar Electronics Corporation, Hsinchu (TW)

(72) Inventors: Zi-Xuan Huang, New Taipei City (TW); Chen-I Lu, Chiayi County (TW)

(21) Appl. No.: 14/305,087

(22) Filed: Jun. 16, 2014

(30) Foreign Application Priority Data
Aug. 22, 2013 (TW) 102130047

(51) Int. Cl. F21V 19/00; F21V 23/00; F21K 99/00

(52) U.S. Cl. CPC F21V 19/003; F21K 9/10; F21V 23/00
USPC 362/382

(57) ABSTRACT

A light emitting module including a complex circuit board, a light emitting element and an electronic element is provided. The complex circuit board has a light emitting element predetermined area, an electronic element predetermined area and an interval area formed between the light emitting element predetermined area and the electronic element predetermined area. The complex circuit board located at the light emitting element predetermined area and the electronic element predetermined area includes a flexible circuit board, a first rigid substrate and a second rigid substrate. The flexible circuit board has an upper surface and a lower surface. The first rigid substrate is disposed on the upper surface. The second rigid substrate is disposed on the lower surface. The flexible circuit board of the complex circuit board located at the interval area is exposed and not covered by the first rigid substrate or the second rigid substrate.

This application claims the benefit of Taiwan application Serial No. 102130047, filed Aug. 22, 2013, the subject matter of which is incorporated herein by reference.

### BACKGROUND OF THE INVENTION

1. Field of the Invention

The invention relates in general to a light emitting module, and more particularly to a light emitting module having a complex circuit board.

2. Description of the Related Art

Along with the maturity in the technology of light emitting diode (LED), LED lamps have gradually replaced conventional incandescent light bulbs and fluorescent tubes. However, in an LED lamp, the connection between LED strips or the connection between LED strips and a driver is generally implemented by soldering, and the space reserved for the use of soldering points cannot be used for placing LEDs. Thus, it is not easy to assemble an LED lamp.

Therefore, the invention provides a light emitting module capable of resolving the problems, such as space waste and assembly difficulty, which are caused by conventional soldering.

### SUMMARY OF THE INVENTION

The invention is directed to a light emitting module. Through the disposition of a complex circuit board, the light emitting module effectively utilizes the space for placing LEDs on a light strip, avoids dark bands, saves assembly time and reduces the complexity of assembly.

According to one embodiment of the present invention, a light emitting module including a complex circuit board, a light emitting element and an electronic element is provided. The complex circuit board has a light emitting element predetermined area, an electronic element predetermined area and an interval area formed between the light emitting element predetermined area and the electronic element predetermined area. The complex circuit board located at the light emitting element predetermined area and the electronic element predetermined area includes a flexible circuit board, a first rigid substrate and a second rigid substrate. The flexible circuit board has an upper surface and a lower surface opposite to the upper surface. The first rigid substrate is disposed on the upper surface of the flexible circuit board. The second rigid substrate is disposed on the lower surface of the flexible circuit board. The complex circuit board located at the interval area includes an exposed flexible circuit board whose upper and lower surfaces are not covered by the first rigid substrate or the second rigid substrate. The light emitting element is disposed on a surface of the first rigid substrate of the light emitting element predetermined area. The electronic element is disposed on a surface of the first rigid substrate of the electronic element predetermined area. The first rigid substrate and the second rigid substrate are electrically connected to each other through the flexible circuit board. The light emitting element and the electronic element are also electrically connected to each other through the flexible circuit board.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a partial schematic diagram of a light emitting module on the X-Y plane according to an embodiment of the invention.

FIG. 2 is a partial cross-sectional view of the complex circuit board of FIG. 1 on the X-Z plane.

FIG. 3 is a schematic diagram of the light emitting module of FIG. 1 placed in the light bulb.

FIG. 4 is a schematic diagram of a light emitting module according to another embodiment of the invention.

FIG. 5 is a partial schematic diagram of the light emitting module of FIG. 4 placed in an elongated tube.

### DETAILED DESCRIPTION OF THE INVENTION

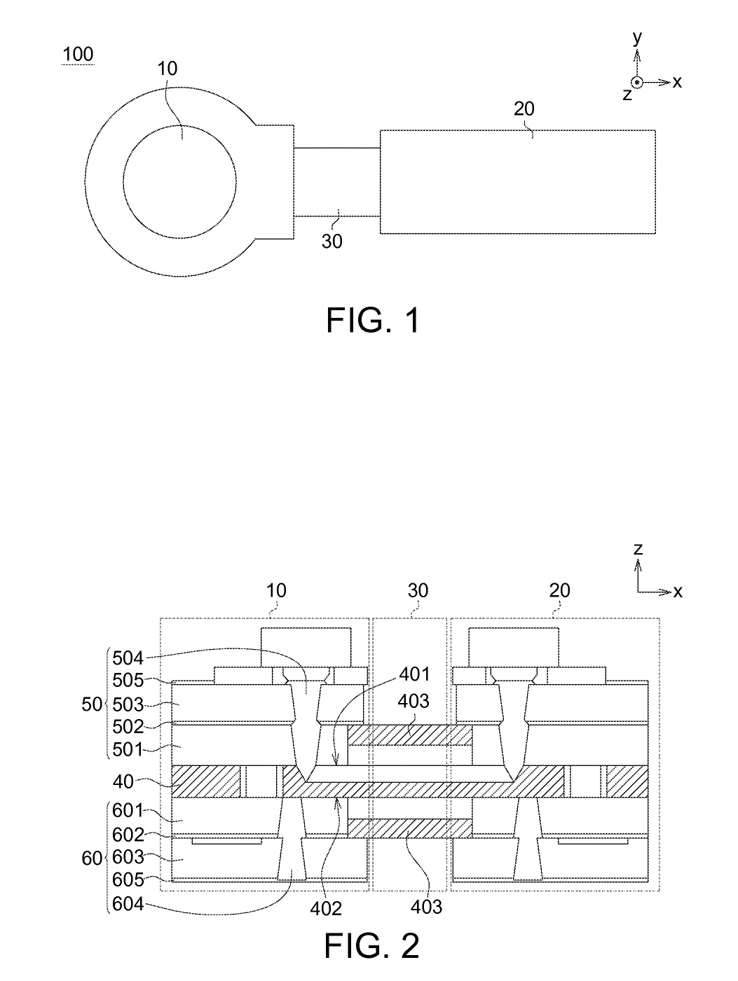

The light emitting module of the invention includes a complex circuit board, a light emitting element and an electronic element. FIG. 1 is a partial schematic diagram of a light emitting module on the X-Y plane according to an embodiment of the invention. As indicated in FIG. 1, the complex circuit board 100 has a light emitting element predetermined area 10, an electronic element predetermined area 20 and an interval area 30 formed between the light emitting element predetermined area 10 and the electronic element predetermined area 20. The light emitting element predetermined area 10 is for placing the light emitting element, and the electronic element predetermined area 20 is for placing the electronic element.

FIG. 2 is a partial cross-sectional view of the complex circuit board 100 of FIG. 1 on the X-Z plane. As indicated in FIG. 2, the complex circuit board 100 located at the light emitting element predetermined area 10 and the electronic element predetermined area 20 includes a flexible circuit board 40, a first rigid substrate 50 and a second rigid substrate 60. The flexible circuit board 40 has an upper surface 401 and a lower surface 402 opposite to the upper surface 401. The first rigid substrate 50 is disposed on the upper surface 401 of the flexible circuit board 40. The second rigid substrate 60 is disposed on the lower surface 402 of the flexible circuit board 40. In an embodiment, the complex circuit board 100 located at the interval area 30 includes an exposed flexible circuit board 40 whose upper and lower surfaces are not covered by the first rigid substrate 50 or the second rigid substrate 60. In an embodiment, the upper and lower surfaces of the exposed flexible circuit board 40 of the interval area 30 can be covered by a third insulation layer 403 as indicated in FIG. 2.

The light emitting element of the light emitting module, such as an LED or an LED strip, can be disposed on a surface of the first rigid substrate 50 of the light emitting element predetermined area 10. The electronic element of the light emitting module, such as a driver, can be disposed on a surface of the first rigid substrate 50 of the electronic element predetermined area 20. The first rigid substrate 50 and the second rigid substrate 60 are electrically connected to each other through the flexible circuit board 40, and the light emitting element and the electronic element are also electrically connected to each other through the flexible circuit board 40.

In an embodiment, the first rigid substrate 50 includes a first substrate 501, a first insulation layer 502 and a first copper film 503. The first substrate 501 is disposed on the upper surface 401 of the flexible circuit board 40. The first insulation layer 502 is disposed on the first substrate 501. The first copper film 503 is disposed on the first insulation layer 502. The second rigid substrate 60 includes a second substrate 601, a second insulation layer 602 and a second copper film 603. The second substrate 601 is disposed on the lower surface 402 of the flexible circuit board 40. The second insulation layer 602 is disposed on the second substrate 601, and the second copper film 603 is disposed on the second insulation layer 602.

In an embodiment, the complex circuit board 100 further includes a first through hole 504 and a second through hole 604. The first through hole 504 penetrates the first copper film 503, the first insulation layer 502 and the first substrate 501, wherein an inner-wall surface of the first through hole 504 is further coated with a first conductor (not illustrated) for electrically connecting to the flexible circuit board 40. The second through hole 604 penetrates the second copper film 603, the second insulation layer 602 and the second substrate 601, wherein an inner-wall surface of the second through hole 604 is further coated with a second conductor (not illustrated) for electrically connecting to the flexible circuit board 40. Besides, the complex circuit board 100 may include two solder masks 505 and 605 disposed on the first copper film 503 and the second copper film 603, respectively.

In the present embodiment of the invention, the light emitting element may be an LED, the electronic element may be another LED or a drive module. The first substrate 501 and the second substrate 601 can be formed of such as glass fiber.

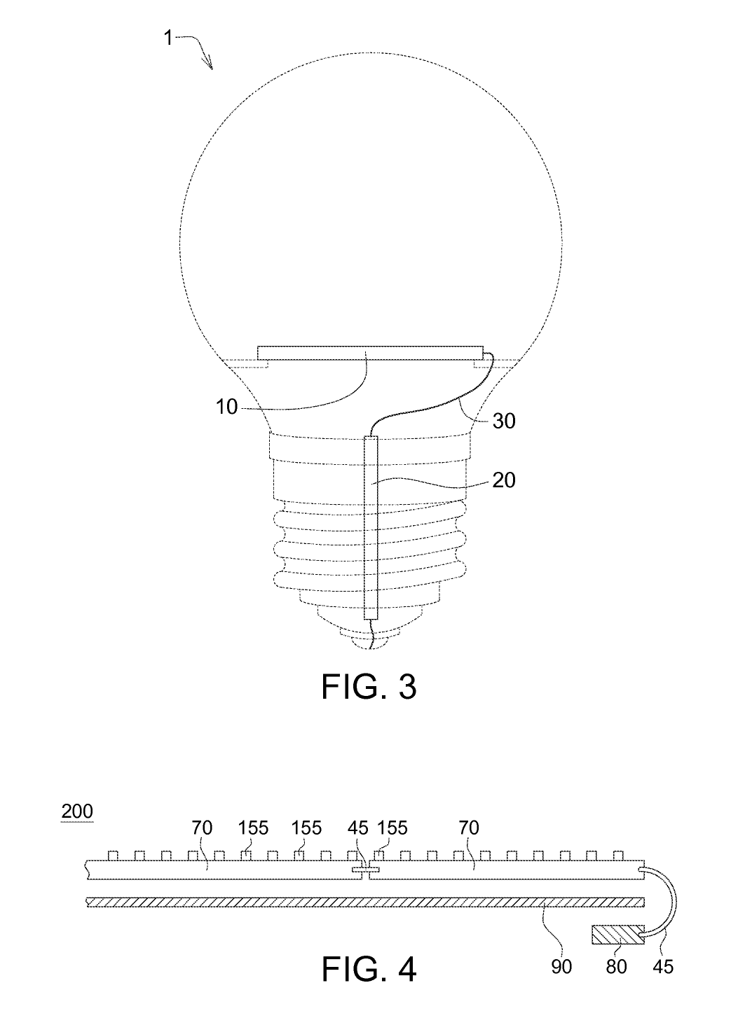

FIG. 3 is a schematic diagram of the light emitting module of FIG. 1 placed in the light bulb. As indicated in FIG. 3, the light bulb 1 has a lamp holder. In the light emitting module, the electronic element predetermined area 20 with a drive module thereon, is disposed inside the lamp holder, and the light emitting element predetermined area 10 with LEDs are thereon, is disposed on the lamp holder. Since the interval area 30 of the complex circuit board 100 is flexible, in an embodiment, the interval area 30 can be bent inside the lamp holder, so that the space on the circuit board and the use of connectors can be effectively saved. Thus, the manufacturing cost can be reduced and the manufacturing process can be simplified.

As indicated in the complex circuit board 100 of FIG. 1, the shape of the light emitting element predetermined area 10 corresponds to the shape of the light bulb, and the electronic element predetermined area 20 is a rectangular circuit board. However, the invention is not limited thereto. Conversely, the shape of the light emitting element predetermined area 10 of the invention may correspond to a light strip, and the shape of the electronic element predetermined area 20 may correspond to another light strip or the shape of another driver module.

FIG. 4 is a schematic diagram of a light emitting module according to another embodiment of the invention. As indicated in FIG. 4, the complex circuit board 200 includes two LED strips 70 and a driver 80. The LED strips 70 and the driver 80 are disposed on the upper and the lower surface of an aluminum extrusion 90, respectively. The two LED strips 70 are connected to each other through a flexible circuit board 45, and the LED strips 70 and the driver 80 are also connected to each other through the flexible circuit board 45. The cross-sections of the LED strips 70 and the driver 80 are similar to FIG. 2, and the similarities are not repeated for simplicity.

Due to the structure of the complex circuit board 200, the LEDs 155 on the LED strips 70 do not need to reserve a space for soldering connectors, such that no dark band will be formed on the LED strips 70. Since the LED strips 70 and the driver 80 are connected to each other through the flexible circuit board 45, the LED strips 70 and the driver 80 can be disposed on the upper surface and the lower surface of the aluminum extrusion 90, respectively, not only saving the overall space but also avoiding the driver 80 being too long which may cause dark band in the light emitting module.

Suppose that the user would like to add a connector to enhance the connection between the two LED strips 70, the added connector does not have to be formed by metal for soldering purpose, and can also be formed by plastics or other materials to save cost because the two LED strips 70 are electrically connected to each other through a flexible circuit board 40.

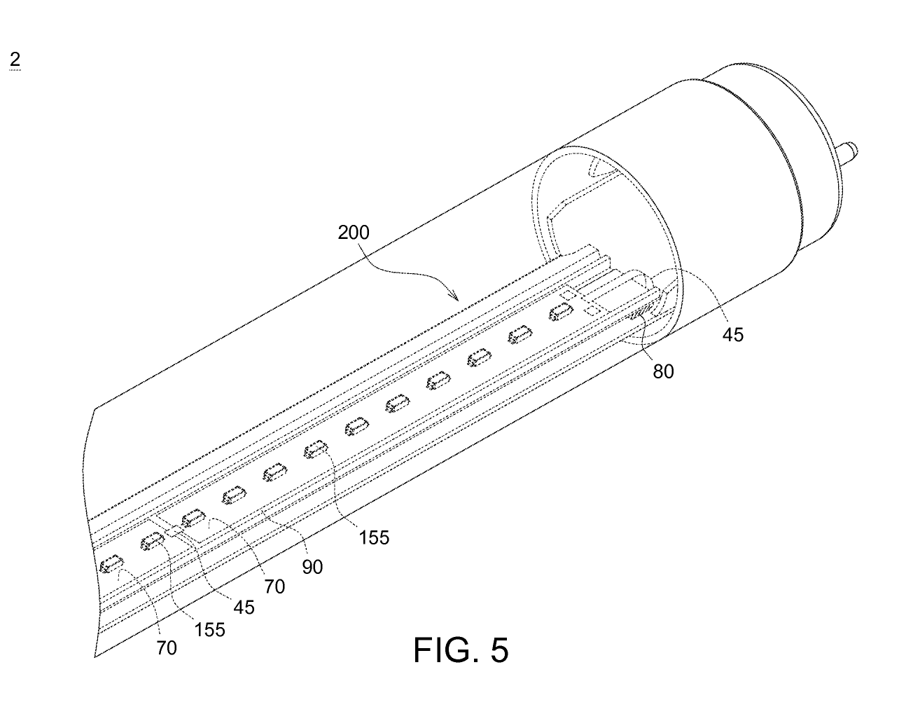

FIG. 5 is a partial schematic diagram of the light emitting module of FIG. 4 placed in an elongated tube. As indicated in FIG. 5, the complex circuit board 200 is disposed inside an elongated tube 2, and the LED strips 70 and a driver 80 are disposed on the upper surface and the lower surface of the aluminum extrusion 90, respectively. The two LED strips 70 are connected to each other through the flexible circuit board 45, and the LED strips 70 and the driver 80 are also connected to each other through the flexible circuit board 45. Although FIG. 5 is exemplified by two LED strips 70, the invention is not limited thereto. Anyone who is skilled in the technology field of the invention can serially connect more LED strips 70 through the flexible circuit board 45 according to actual needs (such as the length of the elongated tube 2).

As disclosed in the embodiments of the invention, the light emitting module uses a complex circuit board, not only effectively saving the space on the circuit board and saving the manufacturing process of connector, but further effectively utilizing the space for placing LED elements. Besides, product assembly is simplified, assembly labor is reduced, and product reliability is improved.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light emitting module, comprising:
a complex circuit board having a light emitting element predetermined area, an electronic element predetermined area and an interval area between the light emitting element predetermined area and the electronic element predetermined area,
wherein the complex circuit board located at the light emitting element predetermined area and the electronic element predetermined area comprises:
a flexible circuit board having an upper surface and a lower surface opposite to the upper surface;
a first rigid substrate disposed on the upper surface of the flexible circuit board; and
a second rigid substrate disposed on the lower surface of the flexible circuit board;
wherein the flexible circuit board of the complex circuit board located at the interval area is exposed and the upper and lower surfaces are not covered by the first rigid substrate or the second rigid substrate;
a light emitting element disposed on a surface of the first rigid substrate of the light emitting element predetermined area; and
an electronic element disposed on a surface of the first rigid substrate of the electronic element predetermined area;
wherein, the first rigid substrate and the second rigid substrate are electrically connected to each other through the flexible circuit board, and the light emitting element and the electronic element are also electrically connected to each other through the flexible circuit board.

2. The light emitting module according to claim 1, wherein the first rigid substrate comprises a first substrate disposed on the upper surface of the flexible circuit board, a first insulation layer disposed on the first substrate, and a first copper film disposed on the first insulation layer, and the second rigid substrate comprises a second substrate disposed on the lower surface of the flexible circuit board, a second insulation layer disposed on the second substrate, and a second copper film disposed on the second insulation layer.

3. The light emitting module according to claim 2, wherein the complex circuit board further comprises:
a first through hole penetrating the first copper film, the first insulation layer and the first substrate, wherein an inner-wall surface of the first through hole is further coated with a first conductor for electrically connecting to the flexible circuit board; and
a second through hole penetrating the second copper film, the second insulation layer and the second substrate, wherein an inner-wall surface of the second through hole is further coated with a second conductor for electrically connecting to the flexible circuit board.

4. The light emitting module according to claim 3, wherein the upper and lower surfaces of the exposed flexible circuit board is further covered by a third insulation layer.

5. The light emitting module according to claim 4, further comprises two solder masks disposed on the first copper film and the second copper film, respectively.

6. The light emitting module according to claim 1, wherein the light emitting element predetermined area is for placing a light emitting element, and the light emitting element comprises a light emitting diode (LED).

7. The light emitting module according to claim 2, wherein the first substrate and the second substrate is formed of glass fiber.

8. The light emitting module according to claim 1, wherein the electronic element predetermined area is for placing an electronic element, and the electronic element comprises a light emitting diode or a drive module.
